(19) United States
(12) Patent Application Publication
(10) Pub. No.: US 2026/0326710 A1
(43) Pub. Date: Oct. 22, 2026

(54) TENSIONING DEVICE FOR A SAFETY BELT COMPONENT

(71) Applicant: AUTOLIV DEVELOPMENT AB, Vargarda (SE)

(72) Inventors: Andre LITTMANN, Alveslohe (DE); Thomas GASTHAUS, Hamburg (DE); Mike NOWAK, Elmshorn (DE); Melanie PLACZEK, Barmstedt (DE)

(21) Appl. No.: 19/109,856

(22) PCT Filed: Sep. 6, 2023
(86) PCT No.: PCT/EP2023/074443

§ 371 Date: Mar. 7, 2025

(30) Foreign Application Priority Data
Sep. 8, 2022 (DE) 10 2022 122 770.7

(51) Int. Cl. B60R 22/46

(52) U.S. Cl. CPC B60R 22/4633; B60R 22/4619

(57) ABSTRACT

A tightening device for a safety belt component, comprising a gas generator for generating a pressurized gas, a piston which can be driven by the pressurized gas, a tension cable which is connected to the piston and can be connected to the safety belt component to be set into a tightening motion, and a tightening tube for receiving and guiding the piston, and a receptacle that accommodates the gas generator.

The present invention relates to a tightening device for a safety belt component, comprising a gas generator for generating a pressurized gas, a piston which can be driven by the pressurized gas, a tension cable which is connected to the piston and can be connected to the safety belt component to be set into a tightening motion, a tightening tube for receiving and guiding the piston and a receptacle that accommodates the gas generator.

Such a tightening device is known, for example, from DE 10 2020 103 157 A1 in which both the receptacle for the gas generator as well as a cable deflection outside the region exposed to the pressurized gas are formed as a single piece in a guide block. A tightening tube is arranged on the guide block, into which the pressurized gas generated by the gas generator enters upon triggering the tightening device so that the piston arranged in the tightening tube is driven by the pressurized gas. On the side facing away from the tightening tube, the cable deflection formed in one piece in the guide block is shaped in such a way that the tension cable can be guided out of the guide block either in a straight line (if necessary offset parallel) in the direction of movement of the piston, or alternatively can be deflected by 90° or more. In order to change the offset of the tension cable to the direction of movement of the piston or to change the deflection angle with such a design of the guide block, the deflection block must be completely redesigned.

From DE 10 2004 023 588A1 , another tightening device is known in which the tension cable is attached to a safety belt component designed as a belt buckle by means of the formation of a loop. A spreader is provided to space the two cable strands of the cable forming the loop. The spreader has a wedge which, at the end of the tightening process, enters a funnel-shaped inlet region of a deflection block, wherein damping occurs through plastic deformation of the wedge. The damping associated with the deformation of the spreading element can reduce the forces acting on the other components of the tightening device or their connection to the motor vehicle. The extent of absorption of kinetic energy via the spreading element can only be adjusted in this case via the properties of the spreading element.

The object of the present invention is therefore that of at least partially eliminating the disadvantages described with respect to the prior art and in particular providing a tightening device which can more easily be adapted to different requirements.

To achieve the object, it is proposed in particular that the tightening device has a frame which is arranged on the side facing away from the tightening tube and through which the tension cable runs after it has emerged from a space of the safety belt component which can be acted upon by the pressurized gas. The frame can, for example, be made from a sheet metal which has been formed in particular into a shape with a U-shaped cross-section. The frame serves in particular to accommodate additional components of the tightening device. In particular, components which serve for cable deflection or cable guidance outside the space exposed to pressurized gas are attached to the frame. The frame can therefore be designed in the same way for different applications of the tightening device, while the components for deflecting the tension cable can be adapted to different applications (e.g. deflection by 90° or straight passage).

The receptacle for the gas generator is arranged in such a way that the pressurized gas generated by the gas generator enters the tightening tube and drives the piston there. Preferably, the receptacle is arranged in the tightening tube.

In addition, a cable guide can be provided through which the tension cable exits the tightening tube. The cable guide is arranged in a suitable sealing manner in the tightening tube and preferably also provides a seal along the tension cable.

Preferably, both the receptacle for the gas generator as well as the cable guide are arranged completely in the tightening tube.

In order to fix the frame to the tightening tube, it can be provided that the frame can have an engagement portion which, in the mounted state, is arranged within the tightening tube. In this case, it can in particular be provided that the engagement section interacts with the cable guide in the mounted state and additionally fixes it in the tightening tube. The cable guide and the engagement section of the frame can accordingly preferably be fixed simultaneously by pressing the tightening tube.

In a preferred embodiment, it is provided that the receptacle for the gas generator and the cable guide are formed as one piece, wherein the receptacle and the cable guide are arranged completely in the tightening tube.

Preferably, the tightening tube has a section with a circular cross-section in which the piston is arranged and along which the piston is driven by the pressure application. The tightening tube also has a region whose cross-section deviates from a circular cross-section. This region preferably has an oval cross-section. The receptacle and the cable guide are arranged in particular in the region of the tightening tube which deviates in its cross-section from the circular cross-section. The receptacle for the gas generator is arranged and designed in such a way that the pressurized gas generated by the gas generator is introduced directly into the tightening tube and can accordingly reach the piston directly. In particular, the pressurized gas is introduced into a region of the tightening tube in which its cross-sectional design changes. The pressurized gas is therefore not introduced into a space limited by the cable deflection and from there guided to the piston. This allows the pressurized gas to cool down slightly before it comes into direct contact with the tension cable arranged in the tightening tube.

A solution to the object mentioned at the outset is provided in particular with a tightening device having the features of independent claim 1. Other solutions and advantageous developments of the tightening device are specified in the description above and in the following as well as in the dependent claims, wherein individual features of the advantageous developments can be combined with one another in a technically sensible manner.

The object is achieved in particular by a tightening device with the features mentioned at the outset, in which the tension cable extends through a frame on the side facing away from the tightening tube, and in that a deformation element is formed on an end region of the tension cable associated with the safety belt component, the deformation element entering the frame at the end of a tightening process, and the frame being designed such that the frame is deformed by the deformation element entering the frame.

In other words, the basic idea of the invention provides that a deformation element is formed on the tension cable which is accelerated with the safety belt component during the tightening process. At least a portion of the deformation element enters the frame at the end of the tightening process, wherein the frame is designed due to its geometry, material properties, arrangement and/or the like such that the frame is elastically and/or plastically, preferably at least plastically, deformed by the deformation element entering the frame. Due to the deformation of the frame, the kinetic energy of the safety belt component is absorbed at the end of the tightening process so that the forces acting on the other components of the tightening device or the forces acting on the attachment of the tightening device to the vehicle are significantly reduced. Since the kinetic energy is absorbed via the frame of the tightening device and accordingly not (at least not solely) via the deformation element, a greater energy absorption exists, or the technical possibilities to influence the energy absorption are increased.

The safety belt component to be accelerated by the tightening device can, for example, be a belt buckle or an end fitting for fixing a safety belt.

In order to enable a defined entry of the deformation element into the frame, it can be provided that the deformation element has an outer peripheral design which tapers along the tension cable in the direction of the frame. For example, the deformation element can have a circular outer circumference, wherein the deformation element tapers in the direction of the frame. Accordingly, the deformation element can have the smallest outer diameter at its end facing the frame. It can also be provided that the outer circumference of the deformation element initially widens in the direction of the frame before it tapers. The deformation element is accordingly at least sectionally convex.

In principle, it is possible for the deformation element to be formed as one piece with the safety belt component or a component of the safety belt component.

Preferably however, the safety belt component is connected to the tension cable, and the deformation element (is attached as an independent component to the tension cable and/or to the safety belt component. The safety belt component can accordingly be connected to the tension cable in a known manner, and the deformation element can be attached to the tension cable as an additional component.

In a particularly preferred embodiment, the safety belt component is positively and/or non-positively connected to one end of the tension cable. In this case, the safety belt component is attached to only just one strand of the tension cable. The tension cable is therefore not designed in a loop shape for attaching the safety belt component.

In a further preferred embodiment, it can be provided that the deformation element is attached as an overmolding on the tension cable and/or on the safety belt component. In this context, it is preferred that the deformation element completely surrounds the tension cable. In particular, the overmolding surrounds the tension cable exclusively just one cable strand of the tension cable. The tension cable is therefore surrounded by the overmolding in one section. In particular, it can be provided in this case that the overmolding is directly connected to an attachment of the safety belt component to the tension cable.

In this context, it is provided in particular that the safety belt component is attached to one end of the tension cable by an attachment section, and that the attachment section is connected to the tension cable by plastic deformation. In this case, the overmolding can be directly connected to the attachment section of the safety belt component, wherein the overmolding additionally seals the attachment section against the tension cable.

As an alternative to the overmolding, it can be provided that the deformation element is pressed, threaded and/or otherwise fixed onto the tension cable and, if applicable, the attachment section of the safety belt component.

It can also be provided that the deformation element sectionally surrounds the attachment section of the safety belt component. The deformation element accordingly forms a kind of grommet which surrounds the attachment section of the safety belt component or also a thimble on the cable. This makes the transition from the tension cable to the safety belt component stiffer, whereby is becomes more difficult for the safety belt component to bend relative to the deformation element at the end of a tightening process. This can be provided in particular if the tension cable is guided more or less straight through the frame.

The deformation element is made in particular of a plastic, aluminum or steel.

In order to easily enable elastic and/or plastic deformation of the frame upon entry of the deformation element, it is preferably provided that the frame is U-shaped in cross section. In this context, it is in particular provided that the frame is formed from a sheet metal which has been formed into a shape having a U-shaped cross-sectional design. In this case, it is in particular provided that the deformation element enters between the legs of the U-shaped cross-sectional design from a side opposite the bottom of the U-shaped cross-sectional design. Alternatively, it can be provided that the deformation element enters between the legs of the U-shaped cross-sectional design parallel to the bottom of the U-shaped cross-sectional design. This can depend in particular on whether the cable is deflected by 90° or whether the tension cable is guided through the tightening device in a straight line or offset in a straight line.

In one embodiment, it can be provided that the frame has an entry design for the deformation element, which can be formed, for example, by the frame widening in the direction of the deformation element. For example, the ends of the frame formed from a sheet metal and having a U-shaped cross-section facing the deformation element can be angled so that a deformation element, in particular tapering conically in the direction of the frame, is guided upon entry into the frame.

In a preferred embodiment, it can be provided that an end cap is placed on the frame, which is in particular formed from a sheet metal. Such an end cap is in particular attached parallel to a bottom of the U-shaped frame, wherein it can be provided in particular that the end cap surrounds the sheet metal both on the inside and on the outside. Such an end cap is also deformed upon the entry of the deformation element into the frame so that another component exists with which the degree of energy absorption can be adjusted. The end cap is in particular made of a plastic.

In a further embodiment of the invention, it can be provided that the tightening device comprises a sheath, wherein the sheath surrounds the tension cable in a region which is arranged between the frame and the safety belt component. The sheath can accordingly support itself on one side of the frame and guides the tension cable to the safety belt component. In addition, the tension cable is accordingly protected from external influences. The sheath can also at least partially surround the safety belt component. The sheath can therefore also be used to align the safety belt component in an unused state. In particular, the sheath also surrounds the deformation element in an initial state. The sheath can in particular be designed such that it is destroyed during a tightening process, wherein in particular, the deformation element ensures during the tightening motion that the sheath is destroyed, for which purpose an outer circumference of the deformation element can be larger than a minimum inner circumference of the sheath in a region into which the tension cable extends in the initial state.

In order to fasten the frame to the tightening tube, it can be provided that the frame formed in particular from a sheet metal has an engagement section which, in the mounted state, is arranged within the tightening tube, wherein it is preferably provided that the engagement section of the frame is fixed to the tightening tube by pressing the tightening tube. For this purpose, it can be provided in particular that the engagement section of the frame has recesses into which the material of the tightening tube is pressed during pressing. In this context, it can also be provided that further components of the tightening device are fixed in the tightening tube when the tightening tube is pressed. For example, a cable guide arranged in the tightening tube and/or a receptacle for the gas generator arranged in the tightening tube can be fixed by pressing the tightening tube.

In one embodiment, it can be provided that a deflection element is arranged in the frame, on which element the tension cable rests during the tightening process, wherein the frame and the deformation element are designed such that the deformation element penetrates into the frame, at least up to the deflection element, at the end of an unloaded tightening process, wherein the deformation element is preferably pulled at least partially along the deflection element and into the frame at the end of the unloaded tightening process.

The deflection element can in particular be mounted in the frame by means of a bushing, wherein the tension cable rests directly on the deflection element. The deflection element is preferably an independent component which is accordingly independent of a cable guide through which the tension cable is guided out of the tightening tube. The deflection element can accordingly be adapted to the particular application of a tightening device without other components of the tightening device having to be changed.

In order to deflect the tension cable, the deflection element has a deflection surface which is circular in cross-section at least in sections and against which the tension cable bears. The deflection element is in particular formed with a deflection surface that is circular in cross section by at least 90°, preferably by at least 120° and particularly preferably by at least 180° on its peripheral surface. The deflection element is arranged in particular in such a way that the tension cable bears against the deflection surface with the inner section of its region deformed by the deflection surface.

For storage in the frame, the deflection element has an in particular circular receptacle through which the bushing is guided. In a particularly preferred embodiment, the circular receptacle is arranged eccentrically to the circular deflection surface of the deflection element, whereby the deflection element can be more easily adapted to different applications (linear passage of the tension cable or deflection of the tension cable). Depending on whether the tension cable is to be deflected by 90° or whether the tension cable is to be guided past the deflection element in a straight line or with an offset to the direction of movement of the piston, different deflection elements can be used. In particular, the receptacle is arranged eccentrically offset towards the circular deflection surface.

It is proposed that the frame and the deformation element are coordinated with one another in such a way that, during an unloaded tightening process in which the safety belt component is not involved/used, it penetrates into the frame at least as far as the deflection element and is preferably at least partially drawn into the frame along the deflection element. The interaction of the deformation element with the deflection element at the end of the tightening process dissipates the remaining kinetic energy, wherein further deformation of the frame can also occur.

The invention and the technical environment are explained below by way of example with reference to the figures. Schematically, in the figures:

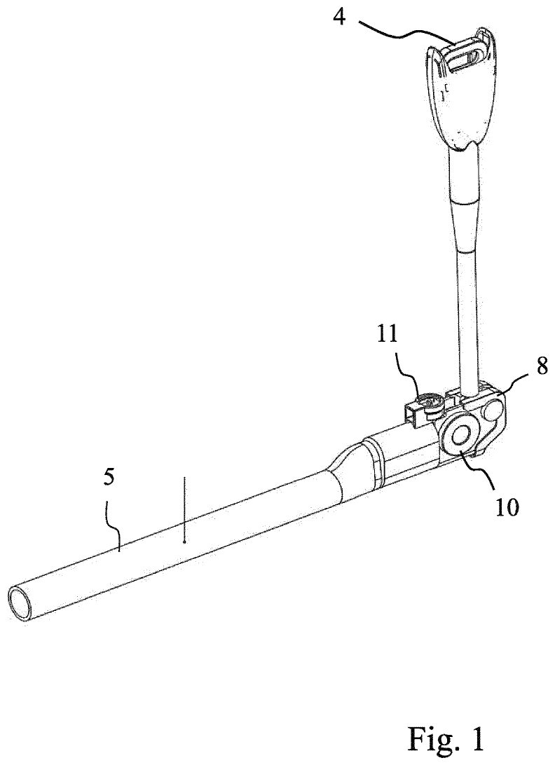

FIG. 1: is a perspective view of a tightening device,

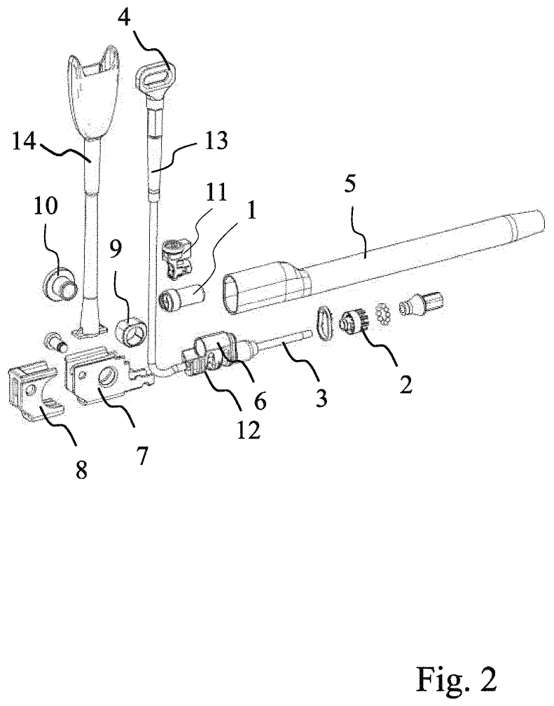

FIG. 2: is an exploded view of the tightening device,

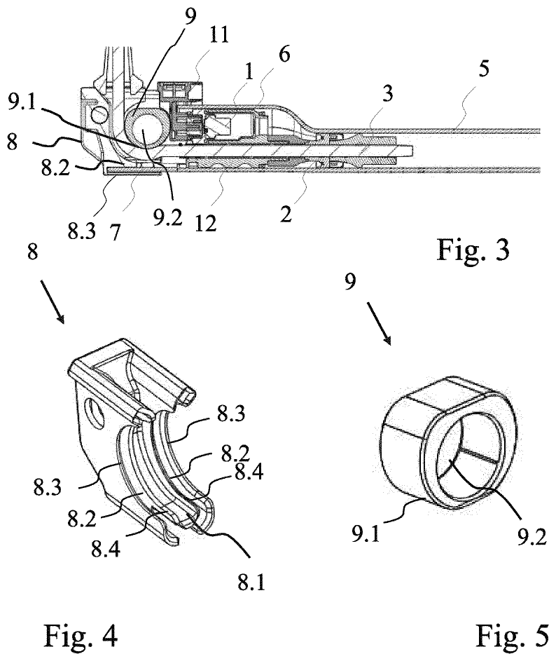

FIG. 3: is a sectional view through the tightening device,

FIG. 4: is a perspective view of an end cap,

FIG. 5: is a perspective view of a deflection element,

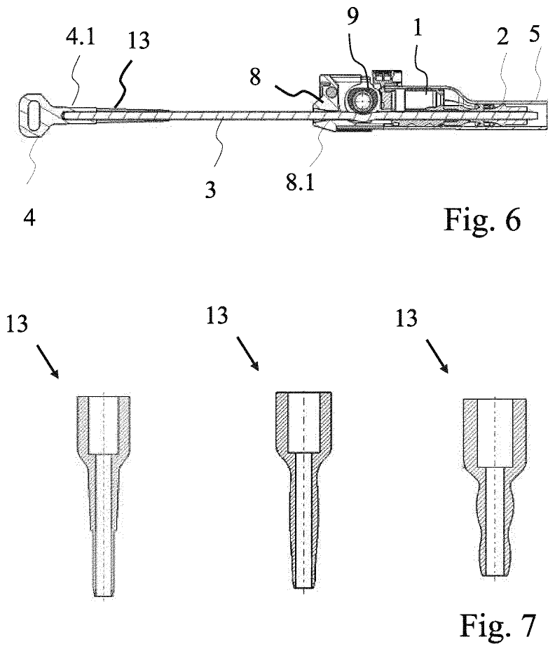

FIG. 6: is a sectional view through another embodiment of a tightening device with a straight cable passage,

FIG. 7: is several designs of a deformation element for the embodiment of the tightening device according to FIG. 6,

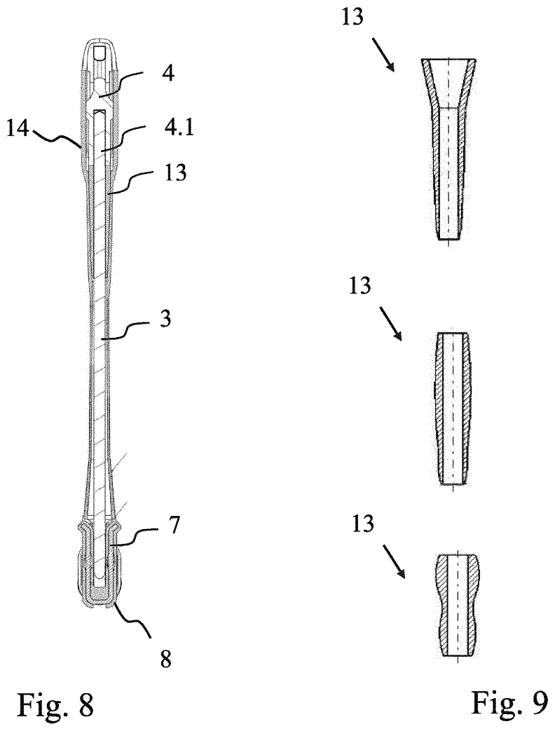

FIG. 8: is a sectional view through the tightening device along a tension cable between a frame and a safety belt component of the tightening device according to FIG. 1 to 3, and

FIG. 9: is several designs of a deformation element for the embodiment of the tightening device according to FIG. 1 to 3.

The tightening device shown in FIG. 1 to 3 comprises a tightening tube 5 in which a piston rod 2 is arranged in a mounted state. The piston 2 is firmly connected to a tension cable 3 which is inserted into the tightening tube 5 and which is connected on its other side to a safety component 4 to be set into a tightening motion.

The tightening device also comprises a component in which a cable guide 12 and a receptacle 6 for a gas generator 1 are formed. In the mounted state, this component is arranged in a section of the tightening tube 5 which has an oval-shaped cross-section.

The tightening device also comprises a frame 7 which, in the mounted state, is arranged with an engagement section within the tightening tube 5.

A deflection element 9 is mounted in the frame 7 by means of a bushing 10, which passes through a receptacle 9.2 of the deflection element 9 in the mounted state and is arranged on both sides of the deflection element 9 in corresponding openings of the frame 7, which is U-shaped in cross section.

The tightening device also comprises an end cap 8 which is attached to the frame 7 from a side facing away from the tightening tube 5.

As can be seen in particular from FIG. 4, the end cap 8 has several sections which, in the mounted state, are arranged within the frame 7.

Accordingly, the end cap 8 has a guide section 8.1 which is arranged within the frame in the mounted state and which is trough-shaped and has a curvature along the direction of the tension cable.

The end cap 8 also has inner sealing sections 8.2 which, in the mounted state, are arranged on the inside of the frame 7 and bear against the frame 7. At the same time, outer sealing sections 8.3 bear against an outer side of the frame 7. By combining inner sealing sections 8.2 and outer sealing sections 8.3, the frame 7 is sealed on the side facing away from the tightening tube 5 so that pressurized gas escaping from the cable guide 12 cannot escape from the front side of the frame 7, but is deflected.

In addition, the side surfaces of the trough-like guide section 8.1 are designed such that when the end cap 8 is inserted, they are pressed onto the tension cable 3 on both sides by the frame 7, whereby the tension cable 3 is secured against unintentional movement. Accordingly, the end cap 8 forms securing sections 8.4. However, the force exerted by the securing sections 8.4 on the tension cable 3 is not so great that the tightening process is hindered.

As can be seen from FIG. 5, the deflection element 9 has an outer surface referred to as deflection surface 9.1 which has a circular shape in the sectional view shown in FIG. 3. The receptacle 9.2 for the bushing 10 is arranged eccentrically to the deflection surface 9.1 and in particular offset towards the deflection surface 9.1.

The tightening device also comprises a plug element 11 via which a cable can be connected to the gas generator 1. The outer contour of the plug element 11 is adapted to the outer contour of the deflection element 9.

In addition, the tightening device comprises a sheath 14 in which the tension cable 3 extends in the initial position from the frame 7 to the safety belt component 4. The safety belt component 4 has an attachment section 4.1 which is attached to the end of the tension cable 3 and is fixed there by pressing. The attachment section 4.1 is followed by a deformation element 13 as an independent component which tapers from the attachment section 4.1 in the direction of the frame 7 (see in particular FIG. 8). The deformation element 13 completely encloses the tension cable 3 and is applied as an overmolding. From FIG. 8 it can also be seen that the frame 7, which is U-shaped in cross section, is angled outwards at its upper end so that an entry design for the deformation element 13 is formed.

To initiate a tightening process, the gas generator 1 is ignited, whereby pressurized gas enters the section of the tightening tube 5 with a circular cross-section and drives the piston 2 there along the tightening tube 5. The driven piston 2 sets the safety belt component 4 into a tightening motion, wherein the tension cable 3 is deflected by the deflection element 9 and the guide section 8.1 of the end cap 8.

While in the exemplary embodiment shown in FIG. 1 to 3 the tension cable 3 is deflected by approximately 90°, the tightening device can also be adapted by exchanging a few parts so that the tension cable 3 exits the frame 7 in a linear extension of the direction of movement of the piston 2.

In the embodiment in FIG. 6, only the end cap 8 has been exchanged, wherein the guide section 8.1 would be designed as an opening through which the tension cable 3 emerges. In order to achieve an optionally different deflection and/or alignment of the tension cable 3, the deflection element 9 can also be designed differently.

FIG. 7 shows different designs of the deformation element 13 for the embodiment of the tightening device according to FIG. 6. In FIG. 9, however, different designs of the deformation element 13 for the embodiment of the tightening device according to FIG. 1 to 3 and 8 are shown. It can be seen that the deformation element 13 tapers on its side facing the frame 7. In this regard, it can also be provided that the outer circumference is designed concave in sections so that the outer circumference first widens towards the frame end and then tapers again. Alternatively, it can also be provided that the outer shape of the deformation element 13 has a step.

In the embodiment in FIG. 1 to 3 and 8, during the tightening process, the deformation element 13 and the safety belt component 4 designed as an end fitting are pulled through the casing 14, which destroys it. At the end of the tightening process, the deformation element 13 enters the frame 7, wherein the frame 7 is elastically and plastically deformed due to the conically expanding shape of the deformation element 13. The deformation of the frame 7 dissipates kinetic energy so that the forces acting on the remaining parts and the fastening of the tightening device to the vehicle are reduced.

With the proposed tightening device, it can therefore only be adapted to other applications by replacing individual components.

### LIST OF REFERENCE SIGNS

1 Gas generator
2 Piston
3 Tension cable
4 Safety belt component
4.1 Attachment section
5 Tightening tube
6 Receptacle
7 Frame
8 End cap
8.1 Guide section
8.2 Inner sealing section
8.3 Outer sealing section
8.4 Securing section
9 Deflection element
9.1 Deflection surface
9.2 Bushing receptacle
10 Bushing
11 Plug element
12 Cable guide
13 Deformation element
14 Sheath

1. A tightening device for a safety belt component, comprising
a gas generator for generating a pressurized gas,
a piston that can be driven by the pressurized gas,
a tension cable that is connected to the piston and is connected to a safety belt component to be set into a tightening motion,
a tightening tube for receiving and guiding the piston, and
a receptacle that accommodates the gas generator,
wherein
the tension cable extends through a frame on the side facing away from the tightening tube, and in that a deformation element is formed on an end region of the tension cable associated with the safety belt component, the deformation element entering the frame at the end of a tightening process, and the frame being designed such that the frame is deformed by the deformation element entering the frame.

2. The tightening device according to claim 1, wherein the deformation element has an outer circumference which tapers along the tension cable in the direction of the frame.

3. The tightening device according to claim 1, wherein the safety belt component is connected to the tension cable, and the deformation element is attached as an independent component to the tension cable and/or to the safety belt component.

4. The tightening device according to claim 3, wherein the safety belt component is connected to one end of the tension cable in a form-fitting and/or force-fitting manner, in particular by a plastic deformation of the safety belt component.

5. The tightening device according to claim 3, wherein the deformation element is attached as an overmolding on the tension cable and/or on the safety belt component.

6. The tightening device according to claim 1, wherein the frame has an entry design for the deformation element that widens in particular towards the safety belt component.

7. The tightening device according to claim 1, wherein the frame is U-shaped in cross section.

8. The tightening device according to claim 1, wherein an end cap is attached to the frame.

9. The tightening device according to claim 1, wherein the tightening device comprises a sheath, wherein the sheath surrounds the tension cable in a region between the frame and the safety belt component, and surrounds the safety belt component at least in part.

10. The tightening device according to claim 1, wherein the frame has an engagement portion which, in the mounted state, is arranged inside the tightening tube, wherein the engagement portion of the frame is fixed to the tightening tube by pressing the tightening tube.

11. The tightening device according to claim 1, wherein a deflection element is arranged in the frame, on which element the tension cable rests during the tightening process, wherein the frame and the deformation element are designed such that the deformation element penetrates into the frame, at least up to the deflection element, at the end of an unloaded tightening process, wherein the deformation element is preferably pulled at least partially along the deflection element and into the frame at the end of the unloaded tightening process.
